(19) United States
(12) Patent Application Publication
(10) Pub. No.: US 2025/0117220 A1
(43) Pub. Date: Apr. 10, 2025

(54) IN-CORE IMPLEMENTATION OF ADVANCED REDUCED INSTRUCTION SET COMPUTER MACHINE (ARM) SCALABLE MATRIX EXTENSIONS (SME) INSTRUCTION SET

(71) Applicant: Microsoft Technology Licensing, LLC, Redmond, WA (US)

(72) Inventor: Skand HURKAT, Bellevue, WA (US)

(21) Appl. No.: 18/481,815

(22) Filed: Oct. 5, 2023

(51) Int. Cl. G06F 9/30; G06F 9/38

(52) U.S. Cl. CPC G06F 9/30036; G06F 9/3013; G06F 9/3887

(57) ABSTRACT

The present disclosure relates to systems and methods that add an outer product engine and an accumulator array to implement Advanced Reduced Instruction Set Computer Machine (ARM)'s scalable matrix extensions (SME) instruction set in an ARM central processing unit (CPU) core. The systems and methods reuse the existing SVE hardware already present in the ARM CPU core for executing the SME instruction set. The systems and methods of the present disclosure use temporal single-instruction multiple data (SIMD) processing an instruction over multiple cycles to reduce memory bandwidth needed in the ARM CPU core to process the SME instruction set.

### BACKGROUND

ARM processors support scalable vector extensions (SVE) with vector lengths that can be chosen between 128 and 2048 bits. ARM supports a programming model that allows code to run and scale across all vector lengths. ARM also has introduced scalable matrix extensions (SME) adding capabilities to ARM to process matrices and support matrix operations, such as, matrix multiplication. ARM specifies the instructions (and their behavior) that comprise the scalable matrix extensions but does not specify an implementation for these instructions.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to an Advanced Reduced Instruction Set Computer Machine (ARM) central processing unit (CPU). The ARM CPU includes a load store unit configured to load data into a vector register file, wherein the load store unit is in communication with a layer 1 cache; an arithmetic unit configured to perform an operation on the data from the vector register file; and an outer product engine configured to implement an ARM scalable matrix extensions (SME) instruction set by performing an outer product of the data, wherein the outer product engine is in communication with the vector register file and the load store unit.

Some implementations relate to a method implemented by an Advanced Reduced Instruction Set Computer Machine (ARM) central processing unit (CPU). The method includes reading, from a first vector register file bank and a second vector register file bank, a first source vector. The method includes reading, from the first vector register file bank and the second vector register file bank, a second source vector in parallel to the first source vector. The method includes computing an outer product of the first source vector and the second source vector. The method includes storing, in an accumulator array, the outer product.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

FIG. 1 illustrates an example environment for a current implementation of an ARM's SME instruction set.

FIG. 2 illustrates an example environment for an in-core implementation of an ARM's SME instruction set in accordance with implementations of the present disclosure.

FIG. 3 illustrates an example environment of an ARM CPU in accordance with implementations of the present disclosure.

FIG. 4 illustrates an example of using temporal SIMD in an outer product array in accordance with implementations of the present disclosure.

FIG. 5 illustrates an example method for computing an outer product in accordance with implementations of the present disclosure.

### DETAILED DESCRIPTION

The present disclosure is generally related to ARM's SME instruction set extensions. ARM processors support scalable vector extensions (SVE) with vector lengths that can be chosen between 128 and 2048 bits. ARM also has a scalable matrix extensions (SME) instruction set adding capabilities to ARM to process matrices and support matrix operations, such as, matrix multiplication. The SME instruction set implements matrix multiplication as an outer product of vectors. ARM's SME instruction set also includes a number of vector instructions. The vector instructions are a subset of the SVE instructions, referred to in the ISA as “streaming” SVE or SSVE instructions. The ARM SME instruction set requires an outer product engine and an accumulator array.

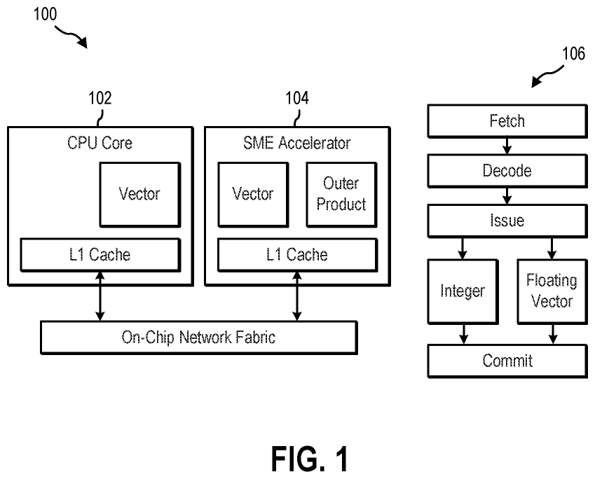

Current implementations of ARM's SME instructions implement the SME instruction set as a separate unit, which may or may not be shared between multiple cores. FIG. 1 illustrates an example environment 100 of a current implementation of an ARM's SME instruction set with the SME accelerator 104 (also referred to as streaming mode compute unit (SMCU) in the ARM specifications) as a separate unit from the central processing unit (CPU) 102. The outer product engine and the accumulator array are added in the SME accelerator 104. Having the SME accelerator 104 separate from the CPU 102 has a drawback that requires the SSVE instruction hardware to be replicated in the SME accelerator 104 as well as in the CPU 102, which is inefficient. The SME accelerator 104 must also have load-store units, cache hierarchy, and a memory management unit, including page table walkers, etc. to handle the SSVE instructions.

A current method 106 performed by the CPU 102 is also illustrated. The method 106 illustrates steps performed by the CPU 102 in processing a vector instruction (e.g., fetch, decode, issue to an integer or floating vector, and commit). As shown in the method 106, the streaming mode with a separate SMCU keeps the CPU's SVE hardware idle while the hardware on the SMCU is used for SSVE instructions.

The methods and systems of the present disclosure add an outer product engine and an accumulator array to implement the SME instruction set to an ARM CPU core. The methods and systems reuse the existing SVE hardware already present in the ARM CPU core for executing the SSVE instructions for the SME instruction set.

The systems and methods of the present disclosure use temporal single-instruction multiple data (SIMD) processing an instruction over multiple cycles to reduce memory bandwidth needed in the ARM CPU core from the layer 1 (L1) cache for outer product instructions. Temporal SIMD refers to executing a single instruction over multiple data in the time domain.

In some implementations, to achieve temporal SIMD, the vector register file includes a plurality of vector register file banks that are loaded in a time-multiplexed manner and read out in lock step for outer product instructions. The plurality of vector register file banks may be read out in sequence for SSVE instructions. Each instruction operates on a fixed number of vector elements that are accessed sequentially in time from the plurality of vector register file banks. In some implementations, the register file includes two vector register file banks.

As used herein, a “register file” refers to a hardware unit in which data may be written to or read from in accordance with implementations described herein. In some implementations, the register file includes multiple register file banks on which instances of data may be written to and stored over one or more cycles (e.g., clock cycles).

In some implementations, the systems and methods increase the vector length to 1024 and use an outer product array that is 256 bits wide. The systems and methods of the present disclosure use temporal SIMD and a vector register file with two vector register file banks, which is loaded in a time-multiplexed manner and read out in lock step. The source vectors are divided into four segments and provided to the vector register file banks. Both vector register file banks store both source vectors. Using two register file banks allows the ARM CPU core to read out a wider vector than the width of the load/store datapath to the L1 cache. For example, a first vector register file bank stores the four segments of a first source vector and four segments of a second source vector, and a second vector register file bank stores different four segments of the first source vector and different four segments of the second source vector. The outer product array computes the product of the source vectors in an order over one or more cycles. The products of the source vectors are accumulated in the ZA array and output as a result of the multiplication.

One technical advantage of the systems and methods of the present disclosure includes minimizing the ARM CPU resources and power required for processing SME instructions. By reusing the vector hardware (e.g., the load-store datapath, the vector register file, L1 cache, and memory management unit) from the ARM CPU core with SME instructions, the ARM CPU resources, and power required for processing SME instructions is minimized. Another technical advantage of the systems and methods of the present disclosure includes using temporal SIMD to process the SME instructions. Another technical advantage of the systems and methods of the present disclosure is using temporal SIMD to increase the arithmetic intensity (the operations performed for every byte of data moved) for the SME outer product operation, allowing more operations to be performed for a given bandwidth between CPU core and L1 cache.

The systems and methods of the present disclosure allow the existing vector hardware for SVE instructions in an ARM CPU core to be used for the SSVE instructions. When the ARM CPU enters streaming mode using a streaming mode start (SMSTART) instruction, the contents of the vector register file (Z registers) and the accumulator array (ZA registers) are cleared. For example, clearing the contents of the vector register file and the accumulator array may be done by resetting either the contents of the register file, or using a sidecar register file that stores the live states of each register and resetting these to uninitialized or zero. Similarly, when the ARM CPU exits streaming mode using a streaming mode stop (SMSTOP) instruction, the same mechanism can be used to clear the ZA storage and the Z registers in the SME mode.

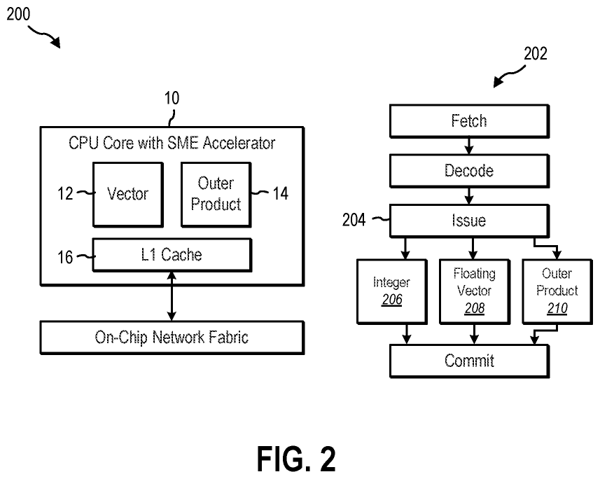

Referring now to FIG. 2, illustrated is an example environment 200 for an in-core implementation of an ARM's SME instruction set. The environment 200 includes an ARM CPU 10 with a vector register file 12, an outer product engine 14, and a L1 cache 16.

An example method 202 performed by the ARM CPU 10 is illustrated for processing the SSVE instructions for the SME instruction set using the in-core implementation of the environment 200. At 204, the issue step may include any of an integer instruction (206), a floating vector instruction (208), and an outer product instruction (210). The ARM CPU 10 is able to perform the SME instruction set using outer product engine 14 and existing vector hardware on the ARM CPU 10.

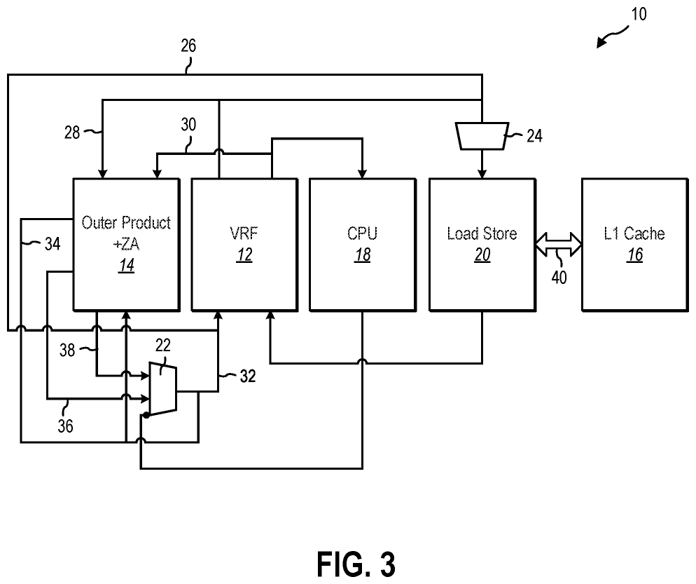

Referring now to FIG. 3, illustrated is an example of an ARM CPU 10 that implements an ARM SME instruction set. A load store unit 20 of the ARM CPU 10 is in communication with a layer 1 (L1) cache 16 on the ARM CPU 10 via a datapath 40. The load store unit 20 retrieves the data from the L1 cache 16 via the datapath 40 and provides the data for storage in the L1 cache 16 via the datapath 40. In some implementations, the datapath 40 is a 128-bit SVE datapath.

The ARM CPU 10 includes an arithmetic unit (e.g., the floating point unit 18) and a vector register file 12. While a floating point unit 18 is illustrated, any arithmetic unit may be used in the ARM CPU 10. The load store unit 20 provides the data to the vector register file 12. The vector instructions retrieve the data from the vector register file 12, sends the data through the floating point unit 18, and writes the results back to the vector register file 12.

The ARM CPU 10 also includes the outer product engine 14 and accumulator array (ZA). The outer product engine 14 is an array of adders and multipliers that is used to multiply source numbers and add the source numbers together. The outer product engine 14 implements matrix multiplication of source vectors as an outer product of vectors (as required by the ARM SME instruction set) and the accumulator array (ZA) stores the outer product of vectors generated by the outer product engine 14. An outer product of vectors is a matrix whose entries are all products of an element in a first vector with an element in a second vector. In some implementations, the register file includes a register file bank that stores the source vectors (e.g., a first source vector and a second source vector) used in the outer product matrix multiplication performed by the outer product engine 14.

A datapath 30 is provided in the ARM CPU 10 from the vector register file 12 to the outer product engine 14. Data from the vector register file 12 may move between the vector register file 12 and outer product engine 14 and the accumulator array (ZA) using the datapath 30. For example, the vector register file 12 reads the data from the accumulator array (ZA) using the datapath 30. Another example includes the vector register file 12 provides data to the outer product engine 14 using the datapath 30. A multiplexer 22 is added to the ARM CPU 10 to select whether the vector register file 12 reads the data from the floating point unit 18 or the output of the outer product engine 14 (e.g., the datapaths 36 and 38).

Datapaths 26, 28, and 34 are provided in the ARM CPU 10 between the load store unit 20 and the outer product engine 14. Data may move between the load store unit 20 and the outer product engine 14 using the datapaths 26, 28, and 34. A multiplexer 24 is added in the ARM CPU 10 to select whether the load store unit 20 reads from the accumulator array (ZA) in the outer product engine 14 or the vector register file 12.

The outer product engine 14 computes the product of the source vectors in an order over one or more cycles. The products of the source vectors are accumulated in the ZA array and is provided as output to vector register file 12 or the load store unit 20.

In some implementations, the source vectors are divided into segments and the register file bank stores the source vectors in segments. In some implementations, the vector register file 12 uses temporal SIMD to mitigate a high bandwidth demand to the L1 cache 16 over the datapath 40 and provides the source vectors in segments sequentially to the outer product engine 14. The outer product engine 14 computes the outer product of the two source vectors by using the segments provided by the vector register file 12 over a plurality of cycles. For example, the source vectors are 1024-bit long vectors and divided into four segments and the outer product engine 14 computes the outer product of the two source vectors using an array of one-fourth (¼) the size of each vector on each side.

In some implementations, the vector register file 12 includes multiple register file banks that store the source vectors used in the outer product matrix multiplication performed by the outer product engine 14. Adding more register file banks to the vector register file allows for a wider vector register file bank. For example, the vector register file bank may increase to 256 bits instead of 128 bits with more register file banks.

In some implementations, the vector register file 12 includes two register file banks. For example, a first vector register file bank stores a first source vector and a second source vector, and a second vector register file bank stores different segments of the first source vector and different segments of the second source vector. In some implementations, the outer product engine 14 uses a 256-bit wide outer product array to computer the outer product of the source vectors. By increasing a size of an outer product array used by the outer product engine 14, the number of operations performed each cycle by the outer product engine 14 increases.

The vector register file 12 may use temporal SIMD by reading out segments of the source vectors sequentially in lock step from the plurality of vector register file banks over a plurality of clock cycles and providing the segments to the outer product engine 14. The outer product engine 14 computes the outer product of the source vector segments sequentially in each cycle. By using temporal SIMD to perform the outer product, the ARM CPU 10 may maintain a size of the outer product within a bandwidth requirement of the datapath 40 between the load store unit 20 and the L1 cache 16 while using a larger outer product array to increase the number of operations performed each cycle by the outer product engine 14 to compute the outer product. For example, the bandwidth requirement of the datapath 40 is 128-bits.

The ARM CPU 10 performs the SME instructions using the outer product engine 14 and reusing the existing hardware in the ARM CPU 10 (e.g., the vector register file 12, the floating point unit 18, the load store unit 20, and the L1 cache 16). By reusing the existing hardware in the ARM CPU 10, the ARM CPU 10 resources required for processing SME instructions is minimized. In addition, by using temporal SIMD to process the SME instructions, the bandwidth required to execute the SME instructions is minimized and a size of the outer product remains within the bandwidth requirements of the L1 cache 16, the ARM CPU 10.

While the above example illustrates how SME may be implemented in the ARM CPU 10 over an existing 128-bit SVE datapath (e.g., the datapath 40), given that both SME and SVE are scalable and vector-length agnostic instruction sets, the ARM CPU 10 may be extended to implementations where the architecture vector length can be any of the valid powers of two that are required for SME.

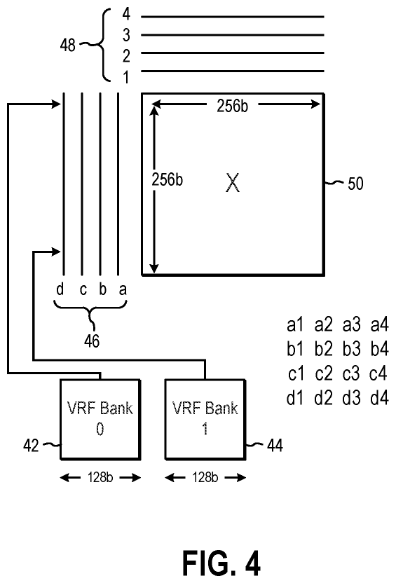

Referring now to FIG. 4, illustrated is an example of using temporal SIMD in computing an outer product array 50 using the outer product engine 14 (FIGS. 2 and 3). In some implementations, the outer product array 50 is the accumulator array (ZA). The outer product engine 14 computes the outer product array 50 from a first source vector and a second source vector. In the illustrated example, the outer product array is a 256-bit wide outer product array and is used by the outer product engine 14 to compute the outer product of 1024-bit long source vectors. While 1024-bit long source vectors are used for illustration purpose in this example, any power of two may be selected. Moreover, the size of the outer product array 50 may change in response to the size of the source vectors.

The first source vector is divided into four segments 46 (a, b, c, d) and the second source vector is divided into four segments 48 (1, 2, 3, 4). In this example, each segment is 256 bits long and each vector register file bank (VRF Bank 0 and VRF Bank 1) has 128-bit read and write ports. The first vector register file bank 42 (VRF Bank 0) holds the lower 128 bits of segments 46 (a, b, c, d) of the first source vector, and segments 48 (1, 2, 3, 4) of the second source vector. The second vector register file bank 44 (VRF Bank 1) holds the upper 128 bits of the same segments (segments 46 (a, b, c, d) of the first source vector, and segments 48 (1, 2, 3, 4) of the second source vector). The VRF banks (VRF Bank 0 and VRF Bank 1) may have multiple read and write ports that allow the two source operands to be read concurrently. By reading both VRF banks (VRF Bank 0 and VRF Bank 1) concurrently, entire segments of the source vectors (e.g., a, b, c, or d, or 1, 2, 3, or 4) can be read at once.

The two vector register file banks (VRF Bank 0 and VRF Bank 1) may be written to in a staggered manner by vector load instructions, thereby using only a 128 bit/cycle bandwidth between the L1 cache 16 and the vector register file 12. Similarly, the vector register file banks (VRF Bank 0 and VRF Bank 1) may also be read in a staggered manner allowing 128 bit/cycle vector stores.

In the illustrated example, two 1024-bit long source vectors are loaded to the outer product array 50 (the ZA array) in sixteen cycles computed as (1024/256)*(1024/256)=4*4 bits/cycle. The outer product engine 14 computes the products a1, a2, a3, . . . d2, d3, d4 in an order and stores the partial products in the outer product array 50 (the ZA array). The order may be any order, since the partial products correspond to different locations in the outer product array 50 (the ZA array). The location for each partial outer product segment is unique, as expressed in Algorithm 1 below.

An example Algorithm 1 the outer product engine 14 uses to perform a temporal SIMD outer product is illustrated below.

Algorithm 1

```
for i in a...d
  for j in 1...4
    ZA[i][j] += v1[i]⊗v2[j]
```

where ZA is the accumulator array, i is a positive integer, j is a positive integer, v1 is a first source vector, v2 is a second source vector, and the += indicates an accumulation, which represents the semantics of the multiply outer products and accumulate (MOPA) instruction. The outer product engine 14 achieves 256-bit reads from vector register file by reading the four segments 46 (a, b, c, d) of the first source vector and the four segments 46 (a, b, c, d) of the second source vector from the first vector register file bank 42 and the different four segments 48 (1, 2, 3, 4) of the first source vector and the different four segments 48 (1, 2, 3, 4) of the second source vector from the second vector register file bank 44 in parallel. The outer product engine 14 computes the outer product of the segments in stages the outer product array 50 (the ZA array) stores the outer product in stages. The load store unit 20 uses a 128-bit datapath 40 to provide the stages of the outer product from the outer product array 50 (the ZA array) to the L1 cache 16. In some implementations, the load store unit 20 provides the outer product stored in the outer product array 50 (the ZA array) to the L1 cache 16 in response to vector load instructions being received. In some implementations, the load store unit 20 reads data from the outer product array 50 (the ZA array) in response to the appropriate store instruction and writes the data to the L1 cache 16, or reads the data from the L1 cache 16, in response to a load instruction and writes the data to the outer product array 50 (the ZA array).

By using an outer product array 50 that is twice as wide as the 128 bits/cycle loaded from the source vectors, the outer product engine 14 can perform four times the arithmetic operations every cycle compared to an outer product engine that is 128 bits wide on each side. By using temporal SIMD to compute the outer product array 50, the memory bandwidth required to calculate the outer product is reduced. For example, the store unit 20 (FIG. 3) provides the outer product from the outer product array 50 to the L1 cache 16 over the 128-bit wide datapath 40.

While the above example illustrates how SME may be implemented in the ARM CPU 10 using a 4× temporal SIMD, the 4× temporal SIMD may be changed to a 2× or even an 8× temporal SIMD, if required. There may be any number of register file banks, where each register file bank holds both source vectors (the first source vector and the second source vector).

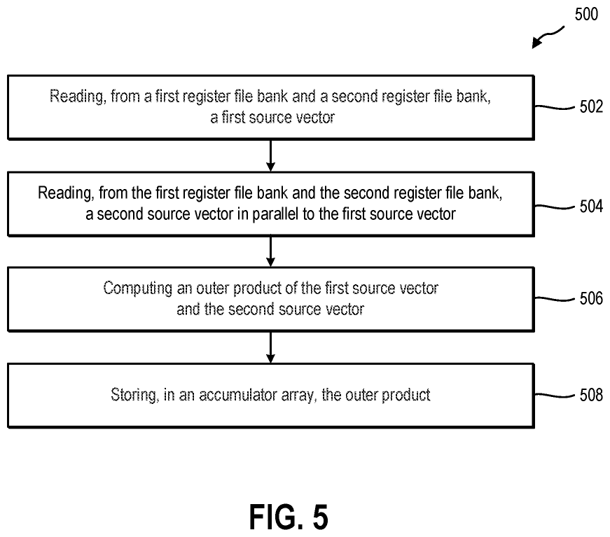

Referring now to FIG. 5, illustrated is an example method 500 for computing an outer product performed by an outer product engine 14 (FIGS. 2 and 3) of an ARM CPU 10 (FIG. 2 and). The actions of the method 500 are discussed below with reference to FIGS. 1-4.

At 502, the method 500 includes reading, from a first vector register file bank and a second vector register file bank, a first source vector. The outer product engine 14 reads the first source vector from the first vector register file bank 42 and the second vector register file bank 44. In some implementations, the first source vector is stored in segments in the first vector register file bank 42 and the second vector register file bank 44 and the plurality of segments of the first source vector are read out sequentially from the first vector register file bank 42 and the second vector register file bank 44 over a plurality of clock cycles.

For example, a size of the first vector register file bank 42 is 128 bits, a size of the second vector register file bank 44 is 128 bits, a size of the first source vector is 1024 bits, and a number of segments of the first source vector in each register file bank is four. In some implementations, a size of the segments of the first source vector is determined by a size of the outer product array (ZA array). For example, the size of the outer product array (ZA array) is determined based on a bandwidth of a connection to the cache 16. In some implementations, a size of the segments of the first source vector is selected so a required bandwidth meets a target that is less than or equal to a maximum bandwidth supported by a connection to the cache 16. In some implementations, a size of the first vector register file bank 42 is less than or equal to a target bandwidth of a connection to the cache 16.

At 504, the method 500 includes reading, from the first vector register file bank and the second vector register file bank, a second source vector in parallel to the first source vector. The outer product engine 14 reads the second source vector from the first vector register file bank 42 and the second vector register file bank 44 in parallel to the first source vector. In some implementations, the second source vector is stored in segments in the first vector register file bank 42 and the second vector register file bank 44 and the plurality of segments of the second source vector are read out sequentially in parallel from the first vector register file bank 42 and the second vector register file bank 44 over a plurality of clock cycles.

For example, a size of the first vector register file bank 42 is 128 bits, a size of the second vector register file bank 44 is 128 bits, a size of the second source vector is 1024 bits, and a number of segments of the second source vector is four. In some implementations, a size of the segments of the second source vector is determined by a size of the outer product array (ZA array). For example, the size of the outer product array (ZA array) is determined based on a bandwidth of a connection to the cache 16. In some implementations, a size of the segments of the second source vector is selected so a required bandwidth meets a target that is less than or equal to maximum bandwidth supported by a connection to the cache 16. In some implementations, a size of the second vector register file bank 44 is less than or equal to a target bandwidth of a connection to the cache 16. The segments of the second source vector and the segments of the first source vector are read out in parallel from the first vector register file bank 42 and the second vector register file bank 44 over a plurality of clock cycles. While two register file banks are discussed as an example, there may be any number of register file banks, where each register file bank holds both source vectors (the first source vector and the second source vector).

At 506, the method 500 includes computing an outer product of the first source vector and the second source vector. The outer product engine 14 computes the outer product of the first source vector and the second source vector.

In some implementations, the outer product engine 14 computes the outer product of the first source vector and the second source vector in stages and the accumulator array stores the stages of the outer product. For example, the outer product engine 14 computes a first outer product of a first segment of the first source vector and a first segment of the second source vector over a first clock cycle and stores the first outer product in the accumulator array; the outer product engine 14 continues to compute outer products of the first segment of the first source vector with subsequent segments of the second source vector over subsequent clock cycles until the outer product is computed for the first segment of the first source vector; and the outer product engine 14 continues to compute outer products of subsequent segments of the first source vector and subsequent segments of the second source vector over subsequent clock cycles is computed for all pairs in the Cartesian product of the segments of the first source vector and the second source vector. In some implementations, a size of the segments of the first source vector and the second source vector and a number of clock cycles is selected based on a target bandwidth of a connection to of the cache 16 to ensure that a size of the outer product remains within the target bandwidth of the cache 16.

At 508, the method 500 includes storing, in an accumulator array, the outer product. The accumulator array stores the outer product of the first source vector and the second source vector, and the output of the accumulator array is available to the vector register file 12 and the load store unit 20. In some implementations, a size of the accumulator array is 256 bits.

The method 500 uses temporal SIMD to provide the data to the outer product engine for performing the outer product of the data over a plurality of clock cycles. The method 500 uses temporal SIMD to maintain a size of the data within a bandwidth requirement for the cache 16 while performing the outer product of the data.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. An Advanced Reduced Instruction Set Computer Machine (ARM) central processing unit (CPU), comprising:
a load store unit configured to load data into a vector register file, wherein the load store unit is in communication with a layer 1 cache;
an arithmetic unit configured to perform an operation on the data from the vector register file; and
an outer product engine configured to implement an ARM scalable matrix extensions (SME) instruction set by performing an outer product of the data, wherein the outer product engine is in communication with the vector register file and the load store unit.

2. The ARM CPU of claim 1, further comprising:
a first multiplexer used by the vector register file to read the data from the outer product engine or the load store unit; and
a second multiplexer used by the load store unit to read the data from the outer product engine or the vector register file.

3. The ARM CPU of claim 1, wherein the outer product engine further includes an accumulator array to store the outer product of the data and an output of the accumulator array is available to the vector register file and the load store unit.

4. The ARM CPU of claim 1, wherein the vector register file uses temporal SIMD to provide the data to the outer product engine for performing the outer product of the data over a plurality of cycles.

5. The ARM CPU of claim 4, wherein the temporal SIMD maintains a size of the data within a bandwidth requirement for a connection to the layer 1 cache.

6. The ARM CPU of claim 4, wherein the outer product engine computes the outer product of the data in stages and an accumulator array stores the stages of the outer product.

7. The ARM CPU of claim 1, wherein the vector register file includes a plurality of vector register file banks and the data from the plurality of vector register file banks is read out in parallel to the outer product engine over a plurality of cycles.

8. The ARM CPU of claim 7, wherein the plurality of vector register file banks equals two vector register file banks, and each register file bank stores segments of both source vectors used in the outer product.

9. The ARM CPU of claim 8, wherein each source vector is stored in segments within the plurality of vector register file banks and the segments are read out in parallel over the plurality of cycles.

10. The ARM CPU of claim 9, wherein a size of each source vector is 1024 bits and a number of segments of each source vector is four.

11. The ARM CPU of claim 7, wherein a size of the plurality of vector register file banks is 128 bits.

12. The ARM CPU of claim 7, wherein a size of an accumulator array used by the outer product engine to store the outer product is 256 bits.

13. A method implemented by an Advanced Reduced Instruction Set Computer Machine (ARM) central processing unit (CPU), comprising:
reading, from a first vector register file bank and a second vector register file bank, a first source vector;
reading, from the first vector register file bank and the second vector register file bank, a second source vector in parallel to the first source vector;
computing an outer product of the first source vector and the second source vector; and
storing, in an accumulator array, the outer product.

14. The method of claim 13, wherein reading from the first vector register file bank and the second vector register file bank the first source vector further includes reading the first source vector in segments over a plurality of clock cycles, and wherein reading from the first vector register file bank and the second vector register file bank the second source vector further includes reading the second source vector in segments over the plurality of clock cycles.

15. The method of claim 14, wherein the outer product is stored in stages in an accumulator array and the stages are provided to a cache from the accumulator array.

16. The method of claim 14, wherein computing the outer product further includes:
computing a first outer product of a first segment of the first source vector and a first segment of the second source vector over a first clock cycle and storing the first outer product in the accumulator array;
continuing to compute outer products of the first segment of the first source vector with subsequent segments of the second source vector over subsequent clock cycles until the outer product is computed for the first segment of the first source vector;
continuing to compute outer products of subsequent segments of the first source vector and subsequent segments of the second source vector over subsequent clock cycles until the outer product is computed for all pairs in a Cartesian product of the segments of the first source vector and the second source vector.

17. The method of claim 14, wherein a size of the segments is selected so a required bandwidth meets a target that is less than or equal to a maximum bandwidth supported by a connection to a cache.

18. The method of claim 14, wherein a size of the segments of the first source vector, a size of the segments of the second source vector, and a number of clock cycles are selected based on a target bandwidth of a connection to a cache.

19. The method of claim 14, wherein a size of the first vector register file bank and a size of the second vector register file bank is equal to a target bandwidth of a connection to a cache or less than a target bandwidth of a connection to the cache.

20. The method of claim 13, wherein a target bandwidth of a connection to a cache is 128 bits, a size of an outer product array is 256 bits, a size of the first source vector is 1024 bits, a size of the second source vector is 1024 bits, a size of the first vector register file bank is 128 bits, and a size of the second vector register file bank is 128 bits.
